(19) United States
(12) Patent Application Publication
(10) Pub. No.: US 2007/0196796 A1
(43) Pub. Date: Aug. 23, 2007

(54) Teaching aid system and method

(76) Inventors: Darren Malone Strother, Lafayette, LA (US); James Timothy Poysky, Lafayette, LA (US)

Correspondence Address: C. Dean Domingue;U.S.Registered Patent Attorney, Perret Doise, APLC, Post Office Box 3408, Lafayette, LA, 70502-3408, US

(21) Appl. No.: 11/358,809

(22) Filed: Feb. 21, 2006

(51) Int. Cl. G09B 5/00

(52) U.S. Cl. 434/169; 434/308

(57) ABSTRACT

A teaching aid system. The teaching aid system comprises a base station controller, a remote control device operatively connected to the base station controller, with the remote control device emitting a signal representative of a tone, and wherein the remote control device is selectively activated. The teaching aid system further includes a microphone operatively connected to the base station controller, with the microphone converting voice into a signal duplicating the voice, and emitting the voice signal. The teaching aid system further comprises a plurality of receivers that receive the tone signal and the voice signal. In the most preferred embodiment, the receivers are an earpiece. A method of redirecting the attention of a student in a classroom is also disclosed.

### BACKGROUND OF THE INVENTION

This invention relates to a teaching aid system. More particularly, but not by way of limitation, this invention relates to a teaching aid system that utilizes a remote control device that generates signals upon command by a teacher, wherein the signal is received by a device worn by the student.

Attention-Deficit/Hyperactivity Disorder (AD/HD) is characterized by the three primary symptoms of hyperactivity, impulsivity, and inattention. As a result, children with AD/HD appear forgetful, have difficulty following directions and completing work, daydream, and make careless mistakes. Due to these characteristics, children with AD/HD miss important instructional material and are at risk for earning low grades that do not accurately reflect their true ability. It is the most common disorder of childhood, and has been estimated to account for approximately fifty percent (50%) of non-routine pediatrician office visits. According to the Center for Disease Control (CDC), seven percent (7%) of the population of the United States has a primary attention disorder (ADD or AD/HD). Of those, approximately 4,290,822 are schools age children (ages 5-19). The trend for this type of diagnosis is increasing (e.g. Blue Cross/Blue Shield) reported 46,902 members treated in 1999, and 85,626 in 2003).

Medications are commonly used to treat attention problems. Up to (80%) of children who are treated only with medication report some improvement in symptoms, but complete resolution of symptoms is rare. In addition, some parents are reluctant to place their child on medication, out of concern of unknown long-term consequences. Based on emerging scientific evidence, these fears may be valid, as commonly used medications have been associated with stroke, heart attacks, and chromosomal mutations that lead to an increased risk of cancer (leading to consumer warnings from the FDA and the National Toxicology Program). Medication can be costly, and prices are consistently increasing.

Based upon research conducted through the National Institute for Mental Health, the most effective treatment for AD/HD is a combination of stimulant medication and behavioral/supplemental interventions. Currently, classroom behavioral/supplemental intervention consists of seating the student close to the teacher, providing verbal re-directions/reminders when the student is off-task, or nonverbal signals from the teacher (e.g. tapping on the student's desk or shoulder). However, these strategies do little to limit distractions, can interrupt the teacher during instruction or other activities, can draw unwanted negative attention toward the student, and can be a source of distraction to the class in general. In addition, research indicates that standard verbal and nonverbal reminders from the teacher can be too complex, and may actually further distract the student.

According to the American Medical Association, diagnosing and monitoring a child with AD/HD requires information about symptoms directly obtained from parents and classroom teachers. This typically consists of parent/teacher rating scales, which can be costly, time consuming, and biased.

Therefore, there is a need for a teaching aid system for students with learning disabilities. There is a need for a system that can be used to teach students with AD/HD and other disabilities. There is also a need for a system that can be employed in multiple classrooms with the ability to track various applications of the system for use by parents, teachers, school administrators and others.

### SUMMARY OF THE INVENTION

A teaching aid system is disclosed. The system includes a base station controller, a remote control device operatively connected to the base station controller, with the remote control emitting an electromagnetic (EM) signal representative of a tone, and wherein the remote control device is selectively activated. The system also includes a microphone, with the microphone converting a voice waveform into an EM signal duplicating the voice waveform, and a plurality of receivers that receive the tone EM signal and the voice EM signal.

In one preferred, the receivers are an earpiece. The EM tone signals will be transmitted at selective frequencies so that there is no interference between receivers. Also, the base station controller can include means for recording and storing the tone EM signal in a digital file format. The occurrence of the generation of the EM tone signal can also be stored in the base station controller as a digital file record. The receivers may contain a proximity sensor for determining whether the receivers leave a predetermined distance from the base station controller. In one embodiment, the base station controller may contain a means for paging the receivers.

The system may also include in one preferred embodiment means, operatively associated with the base station controller, for transferring the digital file record to a central server. The central server may contain a web interface, and wherein a user computer connected to the Internet can access the central server via the web interface.

The system may also include a plurality of base station controllers each located in different classrooms, and wherein within each classroom a remote control device is operatively connected to a single base station controller, and wherein each classroom contains a separate plurality of receivers operatively associated with the remote control device.

In a second embodiment, a teaching aid system is disclosed, and wherein the system includes at a remote location a server, and at a classroom, a base station controller, the base station controller having means for communicating with the server, a remote control device operatively connected to the base station controller, with the remote control device emitting an EM signal representative of a tone, and wherein the remote control device is selectively activated, a microphone for converting a voice waveform into an EM signal that duplicates the voice waveform, and a plurality of receivers that receive the tone EM signal and the voice EM signal.

In this second embodiment, the server contains a web server interface, and the system further comprises at the second remote location a user computer that contains a web server client for communicating with the central server via the Internet. The server contains a plurality of auditory redirection tone files, and wherein the server communicates the auditory redirection tone files to the base station controller, and wherein the auditory redirection tone files contains a plurality of tones having different frequencies. The base station comprises means for recording and storing the occurrence of the generation of the delivery of the tone EM signal into a digital file record.

A method of redirecting the attention of a student in a classroom is also disclosed. The method includes providing a base station controller, a remote control device operatively connected to the base station controller, with the remote control device emitting an EM signal representative of a tone, and wherein the remote control device is selectively activated. The method further includes converting a voice waveform into an EM signal duplicating the voice waveform with a microphone, and receiving the EM voice signal with a plurality of receivers. The method further includes sending an EM auditory redirection tone and receiving the EM auditory redirection tone with the plurality receivers. The occurrence of the generation of the EM auditory redirection tone is stored in a digital data file record in the base station controller. The method further includes transferring the digital data file record to a central server. The generation of the EM auditory redirection tone to the various independent receivers are generated without interfering with the other receivers.

In one embodiment, the method may further include storing a plurality of digital auditory tone files in the central server. The method further comprises transmitting and receiving the plurality of digital auditory tone files to the base station controller.

In another preferred embodiment, a teaching aid system for multiple classrooms is also disclosed. The system comprises within each individual classroom a base station controller, with the base station controller having means for communicating with a server, a remote control device operatively connected to the base station controller, with the remote control device transmitting a signal representative of a tone, and wherein the remote control device is selectively activated. The system further comprises a microphone, with the microphone converting voice waveform into a signal duplicating the voice waveform, a plurality of receivers receiving the tone and the voice signal, and wherein transmission of the signals from the remote control device within one classroom does not interfere with the transmission of signals from another remote control device within another classroom.

An advantage of the present invention includes the benefit of an auditory redirection cue, which allows the teacher to redirect the distracted student without causing unwanted, potentially embarrassing attention to the student. Additionally, the more complex a cue is the more inherent distraction. Thus, verbal redirection from the teacher is, to a degree, a form of distraction. If for example, a student simply appears to be distracted, a verbal cue might cause an otherwise attending student to be distracted. To this end, the present invention will utilize an auditory redirecting cue in the form of a simple, brief tone/sound that is optimized to be as non-distracting as possible while still providing redirection when needed.

Another advantage is that the present system has the ability to send periodic automatic auditory tones providing the student with intermittent redirection. Yet another advantage is automatic tones may be adjusted such that tones occur more frequently for students requiring significant redirection, and less frequently as students begin to learn to monitor their own attention. In this sense, the system functions as an automatic reminder for the student.

Several advantages of having the base station controller produce digital files and uploading/transmitting those files to a central server are produced. Those advantages include real time monitoring that allows them to see up to the minute how often the auditory redirection cue is triggered. Another feature is the customized charts and graphs showing how often and at what times the auditory redirection cue has been triggered. For example, they will be able to view data from the past week, month, or year. Another advantage is the automatic data analysis and reports that identify significant trends, changes, or problem areas that need to be addressed. Yet another advantage is that customers can elect to have charts, graphs, and reports automatically sent via email to recipients of their choosing (e.g. themselves, school counselors, administrators, etc.).

Still yet another advantage is the threshold alarms that can be sent via emails to parents whenever a child's cues exceed a pre-selected amount. Another advantage is the ability to send notifications via automatic email to parents whenever a child's redirection tones are below a pre-selected amount, thereby notifying the parent that the child did not require significant redirection. In addition, alerts can be sent via automatic email whenever redirection tones exceed a predetermined number, thereby notifying the parent that the child required significant redirection. The notifications/alerts can be customized.

A feature of this invention is that the transmission of data and information can be done via hard wire or wirelessly. In the case of hard wire, the signal spectrum may alternating current (AC) or optical. In the case of wirelessly, the signal spectrum may be EM, infrared or optical. A feature of the present invention includes the ability of the system to keep a running tally of the number of times each teacher uses the manual cue. Another feature is that the base station controller would be equipped with a USB port and/or MMC card slot, which would allow tallies to be uploaded on a computer and visualized. This data could then be used to monitor effectiveness of interventions and classroom modifications. The data can be plotted over time to evaluate progress and adapt interventions as needed.

Yet another feature is the proximity monitor which will ensure that the earpiece and/or headpiece does not physically move beyond the transmitter's range. Given that children with AD/HD often misplace and lose things, this device will serve to ensure that children do not wander off and then misplace the earpiece. Yet another feature is that the base station controller may contains means for associating students with the keyfob buttons. For example, an LCD screen on the base station indicates which earpieces are identified as present and which button to push for redirection for each specific student/earpiece (e.g. “John Doe: Green Button”). Another feature is that once a keyfob button is pushed and redirection tone has been sent to a specific student, there will be a brief delay before a subsequent redirection tone can be administered to that student. This will keep frustrated teachers from pressing multiple times for the same, or an ongoing, behavior.

Another feature of this system is the automatic recognition and communication between all the devices in the network. This programming and communication infrastructure is invisible to the students or teacher, and allows teaching to be performed in a non-obtrusive manner.

Another feature is that the base station controller will have a data tracking system that will record when/how often the remote control cue is triggered by the teacher. Another feature is that this data may be stored in a transportable memory device (e.g. memory stick) that can be sent home to parents or given to those involved with the child's care. Another feature is that the base station will also have a phone jack Ethernet jack that will allow the base station to automatically upload the data in real time to the server for use via online services. The base station can also have an internal network adapter that can communicate wirelessly to a local router/hub.

Yet another feature is that the base station controller will include an “automatic cueing” mode that can be set to send an auditory redirection cue to the student at set intervals (e.g. every minute, every two minutes, every three minutes, etc.) without the teacher having to press the remote control device buttons. Still yet another feature is the proximity sensor will be included to alert the student and teacher in the event that the earpiece moves beyond a predetermined area. If the earpiece goes beyond a predetermined distance, it may, in one preferred embodiment, begin to emit a continuous beeping signal, and in another preferred embodiment, a light can be generated on the base station to alert the teacher that the student is leaving with the earpiece.

### BRIEF DESCRIPTION OF THE DRAWINGS

FIG. 1 is a schematic representation of the most preferred embodiment of the present invention.

FIG. 2 is a schematic representation of a single classroom of the preferred embodiment of FIG. 1.

FIG. 3 is a flow chart of the operation of one preferred embodiment of the system.

FIG. 4 is a flow chart of the operation of one preferred embodiment of the earpiece device of the present invention.

FIG. 5 is a flow chart of the operation of a second preferred embodiment of the earpiece device of the present invention.

FIG. 6 is a flow chart of the operation of one preferred embodiment of the microphone device of the present invention.

FIG. 7A is a flow chart of the operation of one preferred embodiment of the remote control device of the present invention.

FIG. 7B is a flow chart of the operation of a second preferred embodiment of the remote control device of the present invention.

### DETAILED DESCRIPTION OF THE PREFERRED EMBODIMENTS

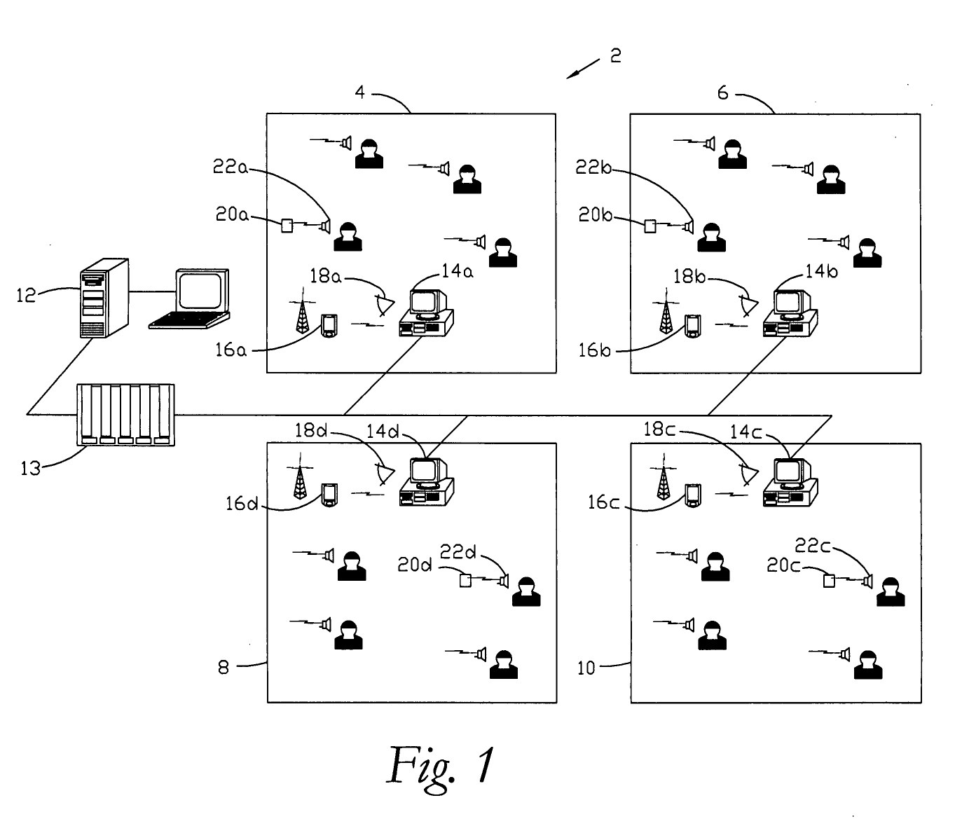

Referring now to FIG. 1, a schematic representation of the most preferred embodiment of the present invention will now be described. More specifically, FIG. 1 illustrates an AD/HD system 2 installed in a multi-classroom setting, namely classroom 4, classroom 6, classroom 8, and classroom 10. In this preferred embodiment, each of the classrooms operates independently, but maintains continuous contact with the central server 12 via the hub 13, and wherein the hub 13 can communicate to classrooms by wire or wireless. The hub 13 acts to collect incoming signals from the classrooms and directs those signals to the central server 12. The central server 12 is commercially available from Dell Inc. under the name Power Edge 6800. The hub 13 is commercially available.

As seen in FIG. 1, each classroom contains similar equipment, namely base station controllers 14a, 14b, 14c, 14d, and remote control devices 16a, 16b, 16c, 16d that are operatively connected to the base stations 14a, 14b, 14c, 14d respectively via conventional cable (hardwired) or wirelessly connected. The base station controllers 14a-14d contain a microprocessor based controller means for storing and processing data. A conventional base station controller is a commercially available computer from Dell Inc. under the name Dell Opti Plex SX 280. The base station controllers 14a-14d are operatively connected to the hub 13, as previously noted, via a hard wire in one preferred embodiment. It should be noted that the base station controllers can be connected to the hub wirelessly via network adapter and router.

In the preferred embodiment of FIG. 1, the remote control devices 16a-16d transmit an electromagnetic (EM) signal representative of an auditory redirection tone, and wherein the remote control devices are selectively activated by the teacher. In other words, the remote control devices emit an EM signal based upon the command of the teacher. It should be noted that the remote control devices may also be referred to as a keyfob. Remote control devices are commercially available from Aurel Inc. under the name TX-4M-5026 SAW 433. The classrooms contain microphones 18a, 18b, 18c, 18d that the teachers wear. The microphones 18a-18d convert the voice of the teacher (i.e. the voice waveform) into an EM signal duplicating the voice of the teacher, and a plurality of receivers 20a, 20b, 20c, 20d that receive the EM voice signal which in turn converts the EM voice signal into the audible voice of the teacher, as is well understood by those of ordinary skill in the art. The microphones can be either connected to the base station controller via cable (hardwired) or wirelessly connected. Microphones are commercially available. As those of ordinary skill will recognize, in the case of hardwired connection between the devices, an alternating current (AC) signal spectrum would be utilized in place of the EM signal. FIG. 1 depicts the most preferred embodiment of utilizing EM waves.

Each student carries the personal receiver (20a, 20b, 20c, 20d) and earpiece 22a, 22b, 22c, 22d. The receivers 20a-20d are connected via hard wire to the earpieces 22a-22d. It should be noted that a headset could be used instead of an earpiece. The student receivers (20a-20b) are logged into the classroom automatically by the base station controller (14a-14d) via a RFID. Hence, in the most preferred embodiment, the base station controllers (14a-14d) are automatically updated as to which students are present. As noted earlier, in the most preferred embodiment, the auditory files are stored in the base station controllers. Also, the occurrence of the generation of the tone EM signals are also stored within the base station controller as a digital file record.

Additionally, as per the teachings of this invention, in one embodiment it is possible that the auditory redirection tones may be digitally stored as files on the central server 12, and these files may be automatically called up for application by the teacher via a command from the base station controllers (14a-14d), so that the auditory redirection tone files may be transferred and stored on the base station controller (14a-14d), and later transferred to the remote control devices.

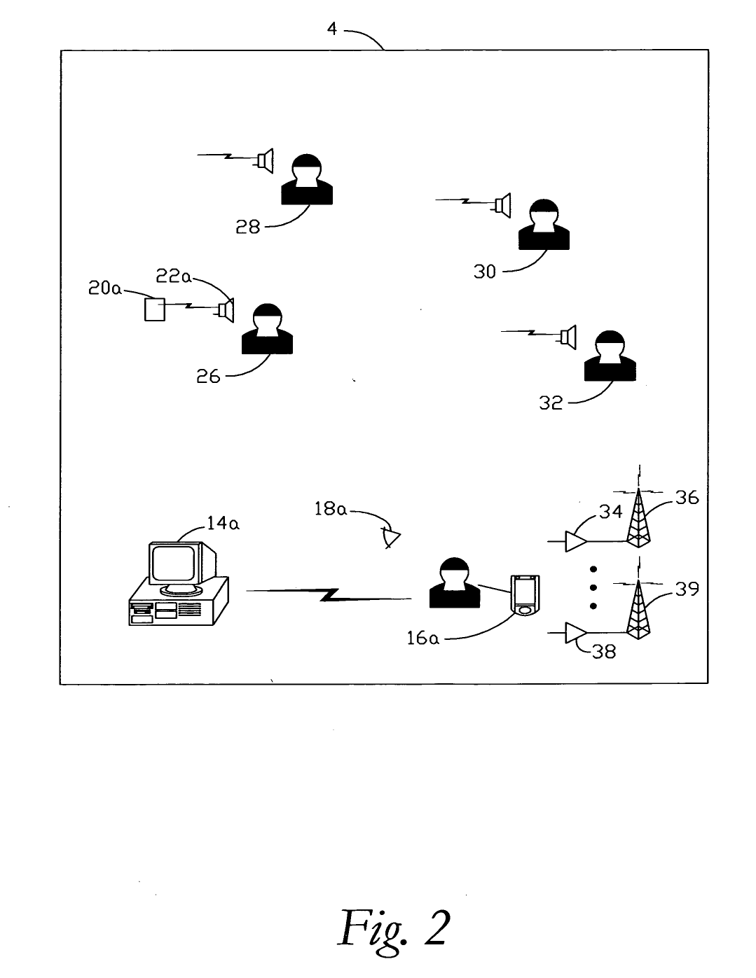

Referring now to FIG. 2, a schematic representation of a single classroom of the embodiment of FIG. 1 will now be described. It should be noted that like numbers refer to like components. Thus, classroom 4 is depicted, and wherein classroom 4 has four students 26, 28, 30, 32. FIG. 2 depicts that the auditory redirection tone signal transmission is independent for each student in the classroom. The remote control device 16a must have multiple audio output channel capability, and the transmission of the EM signals is capable of sending multiple, simultaneous, non-interfering signals to the various student receivers in the classroom. An audio output channel 34 is operatively connected to the transmitter 36, and wherein transmitter 36 will transmit an EM auditory redirection tone signal that can be received by only a single receiver i.e. receiver 20a. Multiple audio output channels are possible. In the embodiment seen in FIG. 2, at least four (4) audio output channels would be required. FIG. 2 depicts audio output channel 38 that is electrically connected to the transmitter 39. The transmitters 36, 39 are commercially available from Listen Technology Inc. under the name LBB 4502/04. Additionally, it should be noted that the base station controller 14a will have a receiver that recognizes the occurrence of the generation of a tone EM by the remote control device 16a and have means for storing the occurrence within the storage means as a digital file record in the base station controller 14a, and wherein this digital file record can then be transferred to the central server as will be more fully described.

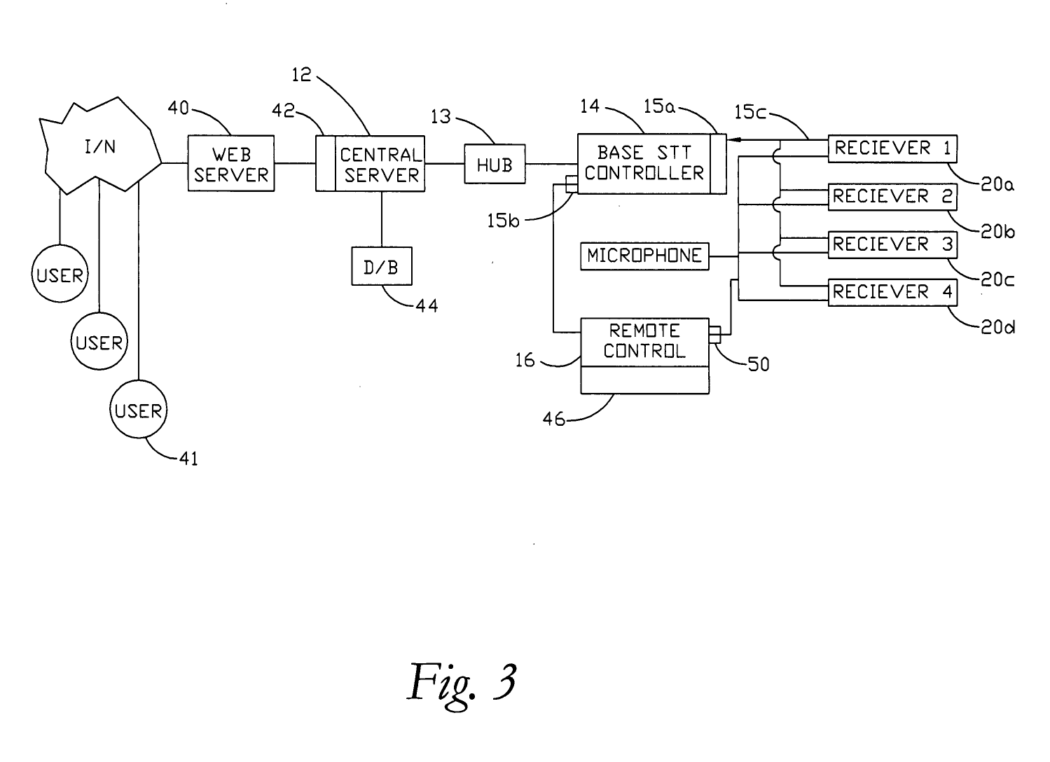

Referring now to FIG. 3, a flow chart of the operation of one preferred embodiment of the system will now be described. The central server 12 is the primary repository for all records and audio redirection tone signal files, for the AD/HD system 2. However, it is possible that the digital file records can be downloaded from the base station controller locally and stored on a SD/MMC/Memory Stick type of device and taken home by the child. In the embodiment of FIG. 3, ethernet connects it to all the local classroom locations via hub 13. The central server 12 is operatively associated with a web server 40 to provide remote, password controlled access to the program functions from anywhere with an Internet connection. A smaller set of information can also be served up for access by user 41, such as teacher, or parents, to view auditory redirection tone transmission digital records. In the preferred embodiment, this second group of users will have view only rights to a restricted set of information based on previously granted permission.

The central server 12 will be in constant communication with all the base station controllers 14 via the hub 13. This will allow the central server 12 to track student and teacher locations as their individual hardware is logged into the base station controller 14 and in turn, with the central server 12 automatically. It is also within the teachings of this invention that log-in can be accomplished directly from base station controller to the central server (i.e. by-passing the hub), and in fact, from the remote control to the central server.

Commercially available hardware will be used for the server 12 and the software applications will be a mix of custom and commercially available software.

As seen in FIG. 3, the database 44 of audio redirection tone signal files are available for the teacher to call up from the server 12 and store on the base station controller 14. These could be parameterized, with, for example: duration, frequency content, amplitude, and so on. The application will support arbitrary signal design via either combining previously defined (or canned) signals, by import of a data file with the signal values (in for example a time/amplitude format) or by direct input (via drawing/digitizer). While the system allows for many variations, in one embodiment, the audio redirection tone signal files simply comprises a plurality of tones that have a limited duration and an increased decibel strength. This embodiment gives the teacher the option of applying a soft tone, a somewhat louder tone, a loud tone, etc, and wherein the decibel strength is determined by the teacher and based upon the amount of redirection is required to regain the student's attention.

According to one embodiment, it is possible that designed signals can be assigned to a specific student. The database 44 contains the students in the teaching system. The student records will track all audio redirection tone signals generated on any student.

Returning to FIG. 3, the audio redirection tone signal files can be downloaded to the base station controller 14 from the server 12 upon command. This download can be done physically from the server 12, or remotely via a web connection. This second instance (web connection) could be on command from the base station controller 14 or from a handheld controller, or from a remote location. In addition, an automatic mode is available in one embodiment that sends a new and/or updated audio redirection tone file from the server 12 to the base station 14.

As seen in FIG. 3, the server 12 will provide a complete HTML web interface 42 to the web server 40, and to all functionality of the system. The home page for the system will provide general information and allow password protected login. There will be multiple levels of login, allowing appropriate access to the system's functions and reports. For example, there may be access granted to students, parents' or guardians, teachers, etc. all with different view and control authority. Control of all the functionality of the system will be available through the web server 40.

The student records will be maintained in the protected database 44 on the central server 12. The database program is commercially available from several vendors under the names Microsoft Access or Sequel Server. The database will have a default student template that can be modified to suit the needs of teachers using the system.

Student records maintained in the database 44 will contain all information related to the student. This could include, but is not restricted to: identification, medical history, audio redirection tone transmission history, current physical location (if logged into the system), reports on the student, and automatically generated reports on the student.

The student database 44 can be accessed as needed through the web server interface 42. This allows third parties, such as researchers, school administrators, etc. to call up records, or alternatively, allows for classroom teachers (via the base station controller 14) to obtain records stored on the database 44. The records requested by the teacher can be stored on the base station controller 14.

In the most preferred embodiment, the base station controller 14 is controlled via a keyboard/mouse interface. Operation is password protected to prevent unauthorized access or use.

In one preferred embodiment, and as noted earlier, the base station controller 14 can be in constant communication with the central server 12. Student records can be pulled down from the central server 12 by the teacher via the base station controller 14. For instance, when a student is logged into the system, the records for that student can be automatically downloaded to the base station controller 14. The digital files will contain the latest records of auditory redirection tone transmission history used on specific students. The base station controller 14 will prompt that it is ready via a prompt displayed locally on the base station controller 14. The base station controller 14 will update the central server 12 as students enter and leave the classroom.

The base station controller 14 will support the fill range of signal design and storage in the case where auditory redirection tone digital files are downloaded from the central server 12.

The base station controller 14 will be in continuous contact with the remote control 16 that is being used by the teacher. This is because the base station controller 14 has a receiver 15a that recognizes the occurrence of the generation of a tone EM signal. The base station controller 14 will also be able to download the auditory redirection tone digital files to the remote control devices via a communications serial port 15b.

In one embodiment (not shown), the remote control device 16 may be a personal digital assistant (PDA) with a custom software application installed thereon. A PDA is commercially available from Dell Corporation. The PDA has a wireless interface, such as WiFi or Bluetooth industry standards, so that the PDA can be in continuous two-way communication with the base station controller 14. The application running on the PDA will provide the teacher with an interface to the base station controller 14 for control and status. The teacher can control transmission of the auditory redirection tone signals to any student in the classroom at any time. The base station controller 14 will allow the teacher to make notes locally and upload them to database 44.

Further as seen in FIG. 3, the audio synthesizer 46 will take the digital data that defines the auditory tones and convert it into an electric audio signal that can drive speakers or headphones directly. It should be noted that the audio synthesizer can also drive a wireless transmitter. The audio synthesizer will support multiple, simultaneous, independent auditory redirection signals. This capability is necessary to allow the auditory redirection signals to customized for each student by the system administrator in order to ensure that the tones maintain efficacious integrity. The audio synthesizer 46 is implemented as audio mixing sound card and is commercially available from M-Audio Inc. under the name Delta 1010T. The audio synthesizer means will be discussed in greater detail later in the application.

As mentioned earlier, the system will contain multiple, simultaneous independent channel transmission capability. In other words, in the preferred embodiment, the transmitter 50 will have to be able to transmit electromagnetic signals at specific frequencies that will not interfere with the multiple receivers within the classroom, and the transmission of the EM signal by the transmitter 50 will be designed so as to not interfere with the other classrooms.

Each transmitter channel will receive the auditory redirection tone signal from the audio synthesizer 46 and encode it for transmission. There may be antennas, or radiators, or loop wiring that is installed in the classroom to support the transmitter 50, wherein the technology used will drive the installation requirements. The transmitter 50 could in fact distribute the signals on a wired network, as analog (baseband or encoded) or digital data. Different types of transmission technologies may be employed which include frequency modulation, amplitude modulation, phase modulation, or pulse modulation. In the most preferred embodiment, frequency modulation (FM) will be employed. Any of the possible technologies are safe for use in proximity to people. Examples of transmitters most appropriate for this application are currently used for simultaneous translation, tour groups, or other similar settings and include commercially available systems from Listen Technology Inc. under the name LT-700.

The receivers 20a-20d and transmitter means 50 are deployed in tandem. Hence, if an FM transmitter means is employed, then the receiver means will be FM as well. In one embodiment, the student receivers 20a-20d comprise the receiver and the earpiece are (or an audio headset) combined into one unit commercially available from Listen Technology Inc. under the name LR-500.

In one embodiment, the receiver could be installed in the classroom, as part of the desk for example. As noted earlier, in the most preferred embodiment, the receiver is an independent unit that the student carries on his person. The receiver decodes the signals that come from the transmitter (wireless or wired) and makes an audio signal capable of driving a headset, earpiece or other audio device for the student. In the most preferred embodiment, the audio component is a digital in the ear (ITE) hearing aid type device. It should also be noted that the audio component could, in one embodiment, be a standard headphone. Each type of audio device may have a different interface requirement, and the system installation must support that type chosen. Note that line 15c represents the transmission capability of the receivers for logging into the base station controller, or for the proximity sensor within the receivers.

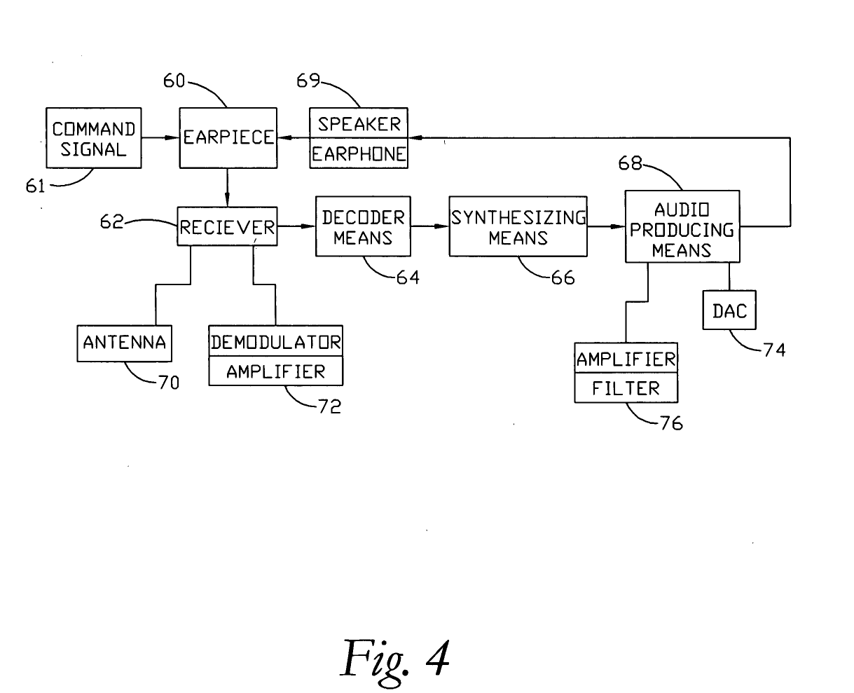

Referring now to FIG. 4, a flow chart of the operation of one preferred embodiment of the earpiece device 60 will now be described. The earpiece device 60 has two major functions: receive a signal (could be directly from the remote control or from the base station), and acting upon that signal, emit a sound into the student's ear.

In the embodiment of FIG. 4, the earpiece 60 receives a command 61 from the control device 16 (as seen in FIG. 3) and then synthesized the cue signal to emit into the student's ear. As shown in FIG. 4, the earpiece hardware comprises a receiving means 62 that receives and demodulates a signal via a wireless medium, for example the industry standards Bluetooth (EM waves), WiFi (EM waves), or infrared (utilizing the optical medium), or other signal spectrum. The decoder means 64 is attached to the receiver that translates the received signal into the command for a cue signal. Synthesizing means 66 is commanded by the decoder to produce the correct cue signal. Audio producing means 68 is connected to the synthesizer to produce the cueing signal. The speaker/earphone means 69 is connected to the audio producing means 68, and wherein the speaker/earphone means 69 emits the signal into the student's ear.

The receiving means 62 may include a commercially available set of electronics (for example commercially available devices that use industry standards Bluetooth, or WiFi receivers), comprising an antenna 70, or alternatively, an appropriate signal pickup means, and a demodulator/amplifier 72 to determine the information encoded in the received signal. The receiving means 62 could also consist of custom electronics operating on a low power unlicensed frequency band that performs the same functions. In either case, the receiving means 62 will output an electronic signal that contains decoded information about the cue signal to be generated.

The decoder means 64 will be electronics, either commercially available microprocessor, digital signal processor, or custom electronics. In the most preferred embodiment, the decoder means 64 is a microprocessor. The decoder means 64 will be programmed (via software, firmware or hardwired logic) to interpret the signal output by the receiving means 62. An appropriate command or sequence of commands will be generated by the decoder means 64 based on the received signal to tell the synthesizing means 66 the type of cue signal to produce.

The synthesizing means 66 will be electronics, either commercially available microprocessor, digital signal processor, or custom electronics. In the most preferred embodiment, the synthesizing means 66 is commercially available from M-Audio Inc. under the name Delta 1010T. The synthesizing means 66 will be programmed (via software, firmware or hardwired logic) to interpret the command or commands output by the decoder means. The cue signal will be synthesized based on the command. This synthesis comprises an algorithm or table look up that will result in a sequence of digital words that represent the cue signal. The digital word will be output to the audio producing means 68.

The audio producing means 68 will be electronics comprising a digital to analog converter 74, and an amplifier/filter 76 to produce the analog audio signal sent to the speaker/earphone means 69. As understood by those of ordinary skill in the art, there will be support electronics such as a battery, power supply, sequencer, etc (not shown) as may be required by the system of electronics in the earpiece.

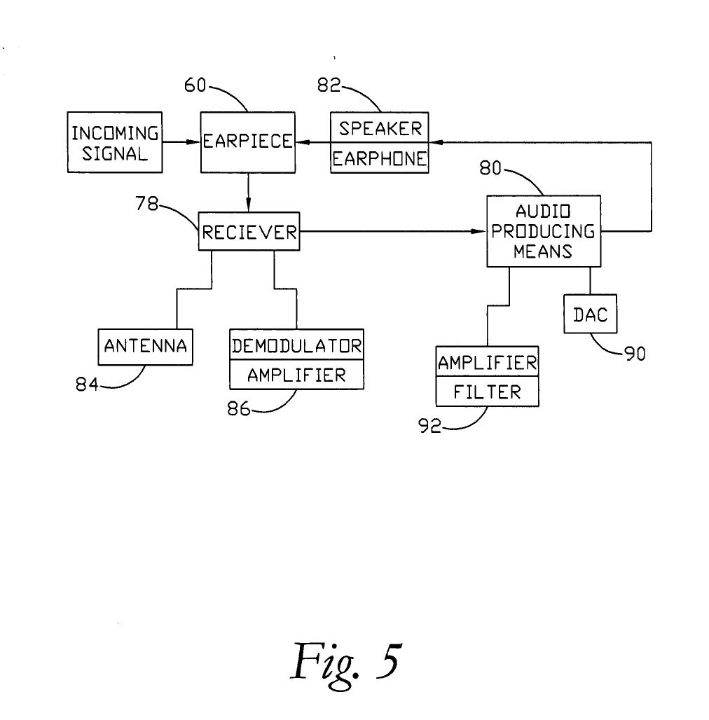

Referring now to FIG. 5, a flow chart of the operation of a second most preferred embodiment of the earpiece device 60 of the present invention. The earpiece 60 receives the cue signal from the remote control device or base station and emits it into the student's ear. The receiving means 78 receives and demodulates the signal via a commercially available wireless medium (for example the Bluetooth standard or the WiFi standard, infrared, or other signal spectrum). In the most preferred embodiment, the wireless medium will be EM waves. Audio producing means 80 connected to the receiver produce the cueing signal. Speaker/earphone means 82 connected to the audio producing means 80 emit the signal into the student's ear.

The receiving means 78 may consist of a commercially available set of electronics (for example Bluetooth, or WiFi receiver), comprising an antenna 84, or alternatively, appropriate signal pickup means, and a demodulator/amplifier 86 to determine the information encoded in the received signal. The receiving means could also consist of custom electronics operating on a low power unlicensed frequency band that performs the same functions. In either case, the receiving means will output a sequence of digital words that contain the cue signal to be generated.

The digital word will be output to the audio producing means 80. The audio producing means will be electronics comprising a digital to analog converter 90, and an amplifier/filter 92 to produce the analog audio signal sent to the speaker/earphone means 82? As understood by those of ordinary skill in the art, there will be support electronics such as a battery, power supply, sequencer, etc (not shown) as may be required by the system of electronics in the earpiece.

Please note that the key distinction between the system of FIG. 4 and FIG. 5 is in the amount of information transmitted over the wireless link. The system of FIG. 4 requires only a small amount of information to be transmitted, allowing a low bandwidth link to be employed. Only a command for cueing the signal is transmitted in FIG. 4. In FIG. 5, the complete cueing signal is transmitted over the wireless link. This requires considerably more bandwidth in the transmission link, wherein the electronics required for the system of FIG. 5 is less than the electronics required for the system of FIG. 4.

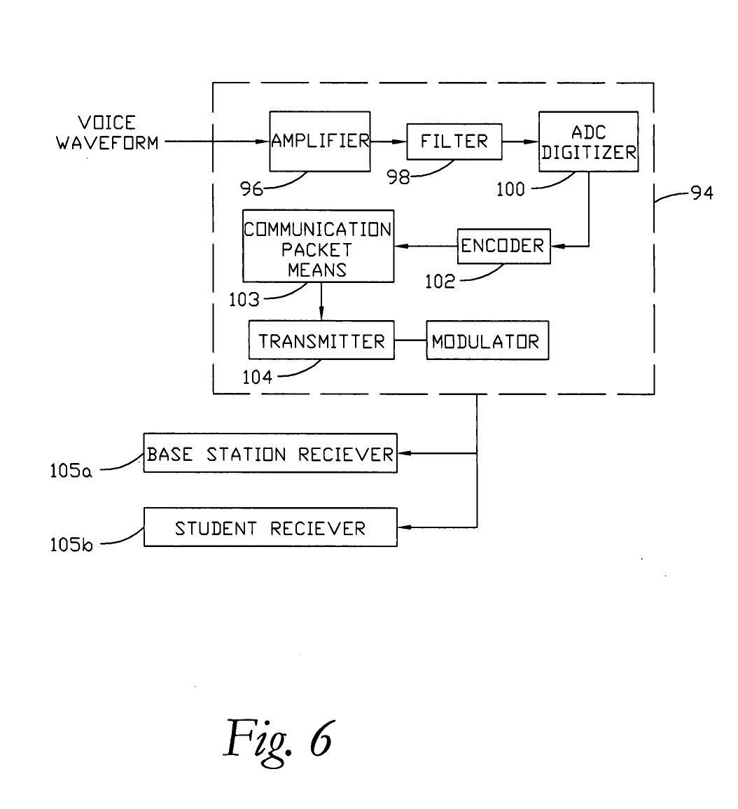

Referring now to FIG. 6, a flow chart of the operation of one preferred embodiment of the microphone device 94 of the present invention will now be described. The microphone device 94, which will pickup the teacher's voice, includes an amplifier 96, filter 98, and analog to digital converter (A/D) 100. The amplifier 96, filter 98, and A/D means which amplify, filter and digitize the voice signal. Encoder means 102 accepts the digitized voice signal and forms communication packets in the communication packet means 103 with appropriate error detection/correction means built in. The transmitter 104 accepts the communication packets from the encoder and modulates them as necessary for transmission to the base station 105a (for relay to the student in one embodiment), or alternatively, directly to the student earpiece 105b directly (which is the most preferred embodiment). The transmission may be over any appropriate spectrum, whether the Bluetooth or WiFi standard, or infrared (IR), or signal spectrum. The teacher's voice (via the microphone) will continuously be transmitted to all students at all times. In the embodiment wherein the microphone 94 transmits to the base station controller, it is possible that the transmission from the teacher's microphone to the base station could be done in one frequency band, and the transmission from the base station to the student earpiece is in another frequency band.

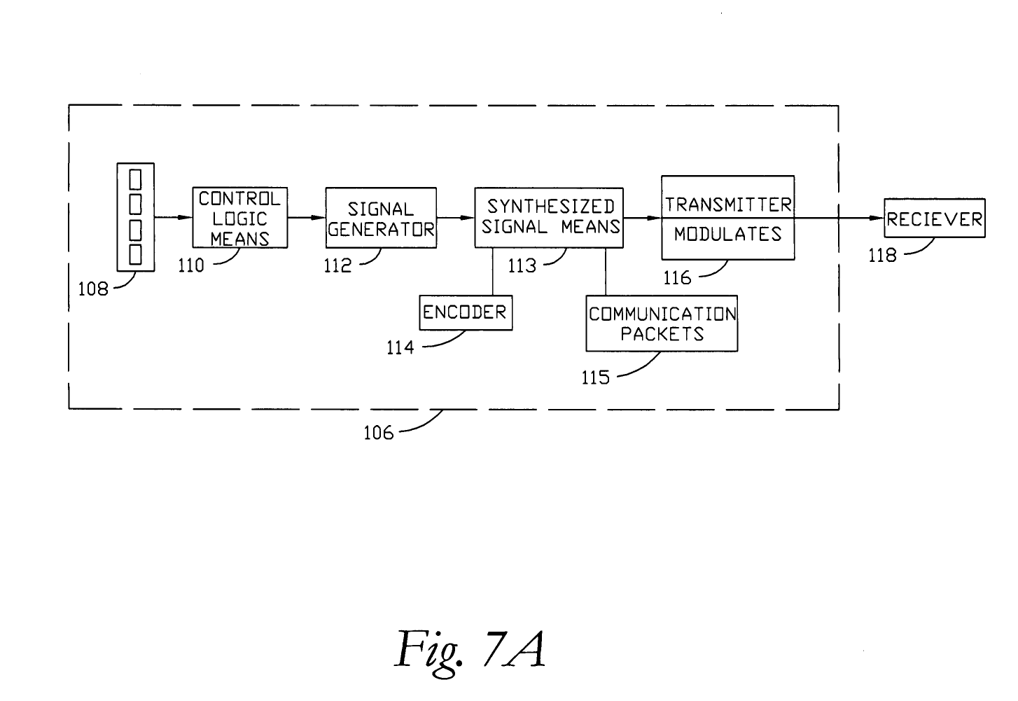

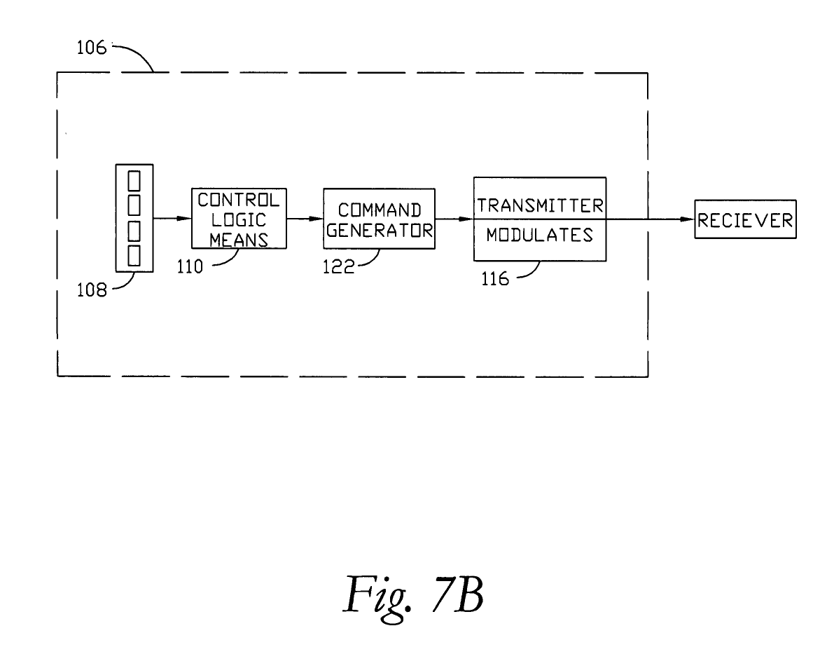

Referring now to FIG. 7A, a flow chart of the operation of one preferred embodiment of the remote control device 106 of the present invention will now be described. The preferred embodiment of FIG. 7A depicts input means 108, which includes single or multiple keys to select different students or signals. The input means could be pushbuttons, membrane keys, alpha, numeric, or alpha numeric keypad for example. Control and logic means 110 would decode the choice from the input means 108. The decoded choice would be communicated to the signal generator 112. Similar to the discussion of the student earpiece of FIG. 5 above, the remote control device 106 would transmit the command that causes the signal to be synthesized in the earpiece, or it could synthesize the signal and transmit the signal directly. FIG. 7A depicts the case where the signal is synthesized in the remote control device 106.

A signal generator means 112 is required to perform the function described immediately above, namely synthesizing the signal and then transmitting the signal. The synthesizer means 113 would be composed of logic, memory, microprocessor, and/or digital signal processor circuitry as required to perform these functions. Encoder means 114 accepts the digitized voice signal and forms communication packets with appropriate error detection/correction means built-in the communication packet means 115.

The transmitter 116 accepts the communication packets from the encoder and modulates them as necessary for transmission to a receiver 118, wherein the base station may have a receiver, and the student earpiece that has a receiver. As noted earlier, the transmission may be over any appropriate spectrum, whether Bluetooth, WiFi, IR or other. It is possible that the transmission from the teacher's microphone to the earpiece could be in one frequency band, and the transmission from the remote control device to the student earpiece is in another frequency band.

Software to perform the above functions would be an application running on a standard PC platform. The software would need to be real-time, interrupt driven. This piece of application code will be substantial in size, encompassing real-time software, hardware interface, database managements, and web client.

FIG. 7B depicts a flow chart of the operation of a second preferred embodiment of the remote control device 106 of the present invention. The embodiment of FIG. 7B depicts the input means 108, which generates a command signal via a command generator 122 that in turn will be sent to the transmitter 116, which in turn will generate an output wave that can be received by receiver 118 of the earpiece, as previously discussed. Hence, the difference between the embodiment of FIG. 7A and FIG. 7B is that in FIG. 7A the entire signal containing the information is being transmitted, and wherein in FIG. 7B only command information is being sent, and the actual information used to generate the tones will be produced by the processor means within the earpiece.

In the preferred embodiment, every time the remote control device is pressed, the activity is logged by the system. This means that there is a communication link from the remote control to the base station. The communication from remote control must be received via a receiver and decoded in the base station controller hardware, the information passed to the software, and then logged appropriately by the software. If multiple students are involved, multiple cues or other complications are a factor, these must all be included in the tracking mechanism.

In another embodiment, in order to store the data on a transportable device, there must be a matching image of the tracked data in a database on the base station controller and the memory stick. Each memory stick will need to be serialized so that the base station controller can differentiate which student records go onto a particular stick.

In one preferred embodiment, the base station controller must be able to function as a web client in order to allow upload and download of data to the server. This client functionality will be integrated with the other application software within the base station.

Additionally, it should be noted that in one embodiment, the automatic cueing to the student can be triggered by command from the remote control or by previous setup of the base station. The base station will have full communication capability with both the remote control device and the student earpiece for this function to be accomplished. A timer loop must be built into the application code to support this functionality. Communication hardware/software would be required to keep in contact with the various elements of the system as disclosed.

Although the present invention has been described in terms of specific embodiments, it is anticipated that alterations and modifications thereof will no doubt become apparent to those skilled in the art. It is therefore intended that the following claims be interpreted as covering all such alterations and modifications as fall within the true spirit and scope of the invention.

We claim:

1. A teaching aid system comprising:
a base station controller;
a remote control device operatively connected to said base station controller, said remote control device emitting a signal representative of a tone, and wherein said remote control device is selectively activated;
a microphone for converting voice into a signal duplicating the voice, and emitting said voice signal;
a plurality of receivers, said receivers receiving the tone signal and the voice signal.

2. The system of claim 1 wherein the receivers are an earpiece.

3. The system of claim 2 wherein the tone signal is emitted at a plurality of selective frequency levels.

4. The system of claim 3 wherein the voice signal is generated using frequency modulation.

5. The system of claim 1 wherein the base station controller comprises means for recording and storing the occurrence of the generation of the tone signal is a digital file record.

6. The system of claim 5 wherein the receivers contain a proximity sensor for determining whether the receivers leave a predetermined distance from the base station controller.

7. The system of claim 5 wherein the base station controller further contains means for transferring the digital file record to a central server.

8. The system of claim 7 wherein said central server contains a web interface, and wherein a user computer can access the central server via the web interface.

9. The system of claim 8 wherein the base station controller contains means for paging the receivers.

10. The system of claim 8 further comprising a plurality of base station controllers located in a plurality of classrooms, and wherein a plurality of remote control devices are operatively connected to said plurality of base station controllers, and wherein each classroom contains a plurality of receivers, and wherein each classroom contains a single remote control device operatively associated with said plurality of receivers.

11. A teaching aid system comprising:
at a remote location:
a central server;
at a classroom:
a base station controller, said base station controller having means for communicating with said central server;
a remote control device operatively connected to said base station controller, said remote control device emitting an electromagnetic (EM) signal representative of a tone, and wherein said remote control device is selectively activated;
a microphone for converting a voice waveform into an EM signal duplicating the voice;
a plurality of receivers, said receivers receiving the tone EM signal and the voice EM signal.

12. The teaching aid system of claim 11 wherein said central server contains a web server interface, and the system further comprises at the remote location a user computer that contains a web server client for communicating with said central server.

13. The teaching aid system of claim 12 wherein the central server contains a plurality of auditory redirection tone files, and wherein said central server communicates said auditory redirection tone files to said base station controller.

14. The teaching aid system of claim 13 wherein said auditory redirection tone files comprises tones having different frequencies.

15. The teaching aid system of claim 12 wherein the receivers are an earpiece.

16. The teaching aid system of claim 15 wherein the tone EM signal is emitted at a plurality of selective frequency levels.

17. The teaching aid system of claim 16 wherein the voice EM signal is generated using frequency modulation.

18. The teaching aid system of claim 11 wherein the base station controller comprises means for recording and storing the occurrence of the generation of the tone EM signal in a digital file record.

19. The teaching aid system of claim 18 wherein the receivers contain a proximity sensor for determining whether the receivers leave a predetermined distance from the base station controller.

20. The teaching aid system of claim 18 wherein the base station controller further contains means for transferring the digital file record to the central server.

21. The teaching aid system of claim 20 wherein said central server contains a web interface, and wherein a user computer can access the central server via the web interface.

22. The teaching aid system of claim 21 wherein the base station controller contains means for paging the receivers.

23. A method of redirecting the attention of a student in a classroom, wherein the method includes:
providing in the classroom: a base station controller; a remote control device operatively connected to said base station controller, said remote control device emitting an electromagnetic (EM) signal representative of an auditory redirection tone, and wherein said remote control device is selectively activated;
converting a voice waveform into an EM signal with a microphone, and wherein the EM signal duplicates the voice waveform;
sending a first EM auditory redirection tone from said remote control device;
receiving the first EM auditory redirection tone with a first receiver that receives the EM auditory redirection tone and the EM voice signal;
receiving the EM voice signal with the first receiver;
storing the occurrence of the first EM auditory redirection tone in a digital file record in the base station controller;
transferring the digital file record to a central server.

24. The method of claim 23 further comprising:
sounding an alarm when the first receiver travels beyond a predetermined distance.

25. The method of claim 23 further comprising:
sending a second EM auditory redirection tone from said remote control device;
receiving the second EM auditory redirection tone at a second receiver without interfering with the first receiver.

26. The method of claim 25 further comprising:
sending a third EM auditory redirection tone from said remote control device;
receiving the third EM auditory redirection tone at a third receiver without interfering with the first or second receiver.

27. The method of claim 23 further comprising:
storing a plurality of digital tone files in the central server;
transmitting the plurality of digital tone files to the base station controller;
receiving the plurality of digital tone files at the base station controller.

28. A teaching aid system comprising:
at a remote location:
a server;
at a central location:
multiple classrooms, wherein each individual classroom contains:
a base station controller, said base station controller having means for communicating with said server;
a first remote control device operatively connected to said base station controller, said first remote control transmitting an electromagnetic (EM) signal representative of a tone, and wherein said first remote control device is selectively activated;
a microphone for converting a voice waveform into an EM signal duplicating the voice waveform;
a plurality of receivers, said receivers receiving the tone EM signal and the voice EM signal;
and wherein transmission of the tone EM signal from said remote control device within one classroom does not interfere with the transmission of tone EM signal from a second remote control device within another classroom.

29. The system of claim 28 wherein said server contains a web server interface, and the system further comprises at the remote location a user computer that contains a web server client for communicating with said server.

30. The system of claim 29 wherein the server contains a plurality of auditory redirection tone files, and wherein said server communicates said auditory redirection tone files to said base station controllers.

31. The system of claim 30 wherein said auditory redirection tone files contains tones having different decibel levels.

32. The system of claim 31 wherein the receivers are an earpiece.

33. The system of claim 32 wherein the tone EM signal is emitted at a plurality of selective frequency levels.

34. The system of claim 33 wherein the voice EM signal is generated using frequency modulation.

35. The system of claim 28 wherein the base station controllers comprise means for recording and storing the occurrence of the generation of the tone EM signal into a digital file record.

36. The system of claim 35 wherein the receivers contain a proximity sensor for determining whether the receivers leave a predetermined distance from the base station controller.

37. The system of claim 35 wherein the base station controller further contains means for transferring the digital file record to the server.

38. The system of claim 37 wherein said server contains means for transferring the digital file record to the user computer.

39. The system of claim 38 wherein the base station controller contains a means for paging the receivers.

40. A teaching aid system for multiple classrooms, the system comprising within each individual classroom:
a base station having a controller, said controller having means for communicating with a server;
a remote control device operatively connected to said base station, said remote control device emitting an electromagnetic (EM) signal representative of a tone, and wherein said remote control device is selectively activated;
a microphone for converting voice into an EM signal duplicating the voice;
a plurality of receivers, said receivers receiving the tone EM signal and the voice EM signal and generating a tone and voice duplicating the tone EM and the voice EM;
and wherein transmission of the tone EM signals from said remote control device within one classroom does not interfere with the transmission of tone EM signal from another remote control device within another classroom.

41. A teaching aid system comprising:
at a remote location: a server;
at a first location: a first teaching aid system operatively associated with a first set of classrooms;
at a second location: a second teaching aid system operatively associated with a second set of classrooms;
wherein said first and second teaching aid system within said first and second set of classrooms comprises;
a base station controller, said base station controller having means for communicating with said server;
a remote control device operatively connected to said base station controller, said remote control transmitting a signal representative of a tone, and wherein said remote control device is selectively activated;
a microphone for converting a voice waveform into a signal duplicating the voice waveform;
a plurality of receivers, said receivers receiving the tone signal and the voice signal and generating a tone and voice duplicating the tone EM and the voice EM;
wherein the occurrence of the transmission of the signals is stored within said base station controller in a digital file record;
and wherein transmission of the signals from said remote control device within said first set of classrooms does not interfere with the transmission of signals from another remote control device within said second set of classrooms.

42. The teaching aid system of claim 41 wherein said server contains a web server interface, and the system further comprises a user computer that contains a web server client for communicating with said server.
